(19) United States
(12) Patent Application Publication
(10) Pub. No.: US 2024/0177699 A1
(43) Pub. Date: May 30, 2024

(54) SIGNAL PROCESSING DEVICE, METHOD AND PROGRAM, ELECTRONIC MUSICAL INSTRUMENT

(71) Applicant: CASIO COMPUTER CO., LTD., Tokyo (JP)

(72) Inventor: Goro SAKATA, Tokyo (JP)

(73) Assignee: CASIO COMPUTER CO., LTD., Tokyo (JP)

(21) Appl. No.: 18/521,689

(22) Filed: Nov. 28, 2023

(30) Foreign Application Priority Data
Nov. 30, 2022 (JP) 2022-192118

(51) Int. Cl. G10H 7/00; G10H 1/00

(52) U.S. Cl. CPC G10H 7/002; G10H 1/0008; G10H 1/0091; G10H 2240/161

(57) ABSTRACT

A signal processing device includes a first memory storing waveform data; a second memory to which the waveform data is being transferred; and a processor configured to execute a first program that imparts a sound effect to samples of the waveform data that have been transferred to the second memory, and a second program that performs burst access to a plurality of samples of the waveform data stored in the first memory so as to transfer the plurality of samples of the waveform data to the second memory, wherein the processor determines an execution schedule of the second program such that a process execution of the first program and a process execution of the second program are respectively completed once in every sampling period of the waveform data.

### BACKGROUND OF THE INVENTION

### Technical Field

The present invention relates to a signal processing device, method, and storage medium used in electronic musical instruments, etc., for adding acoustic effects to generated musical waveform data, for example, and to an electronic musical instrument equipped with the signal processing device.

### Description of Related Art

In a digital signal processor (DSP) for adding acoustic effects to musical waveform data, the musical waveform data stored in an external memory are sequentially read out in each sampling time/period determined by a predetermined sampling cycle, and are transferred to internal memory capable of high-speed processing within the DSP.

The DSP executes effect applying processing on the musical waveform data transferred to the internal memory within the sampling time/period.

### RELATED ART DOCUMENT

### Patent Document

### SUMMARY OF THE INVENTION

An advantage of the present disclosure is in that it provides a signal processing device, method, program and an electronic musical instrument, which ensure consistency between burst access and internal memory access by the signal processing device even when burst access is used for data transfer between the internal memory and the external memory of the signal processing device.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, in one aspect, the present disclosure provides a signal processing device, comprising: a first memory storing waveform data; a second memory to which the waveform data is being transferred; and a processor configured to execute a first program that imparts a sound effect to samples of the waveform data that have been transferred to the second memory, and a second program that performs burst access to a plurality of samples of the waveform data stored in the first memory so as to transfer the plurality of samples of the waveform data to the second memory, wherein the processor determines an execution schedule of the second program such that a process execution of the first program and a process execution of the second program are respectively completed once in every sampling period of the waveform data.

It is to be understood that both the foregoing general description and the following detailed description are exemplary and explanatory, and are intended to provide further explanation of the invention as claimed.

### BRIEF DESCRIPTION OF THE DRAWINGS

FIG. 1 is a block diagram of an embodiment of the present disclosure.

FIG. 2 is a diagram illustrating, as a comparative example, the relationship between execution timings of main program processing and subprogram processing that is executed once every four sampling times/periods.

FIG. 3 is an explanatory diagram for a problem when the execution states of the main program and the subprogram intersect.

FIG. 4 is an explanatory diagram for determining an execution schedule according to a first embodiment.

FIG. 5 is an explanatory diagram for determining an execution schedule according to a second embodiment.

FIG. 6 is a hardware configuration diagram showing an embodiment of EMI.

FIG. 7 is a diagram showing a configuration example of instruction data of a subprogram.

### DETAILED DESCRIPTION OF EMBODIMENTS

The DSP and an external memory are connected to a common bus together with the sound source circuit and the CPU that controls the overall operation of the electronic musical instrument. In such a signal processing device, the access time to the external memory is generally slower than the access time to the internal memory.

If the DSP frequently accesses the external memory to read or write the musical waveform data, the latency (delay) in accessing the external memory and competition with bus access by other circuits may cause a decrease in overall processing speed, and may add noise to the musical sound produced by the electronic musical instrument.

The access time to the external memory can be shortened by using burst access, which is a batch access method between multiple addresses of the second memory, which is the internal memory of the DSP, and multiple addresses of the first memory, which is the external memory.

However, it is difficult to design for ensuring consistency (mutual execution order) between access to the first memory, which is the external memory, and access to the second memory, which is the internal memory of the DPS.

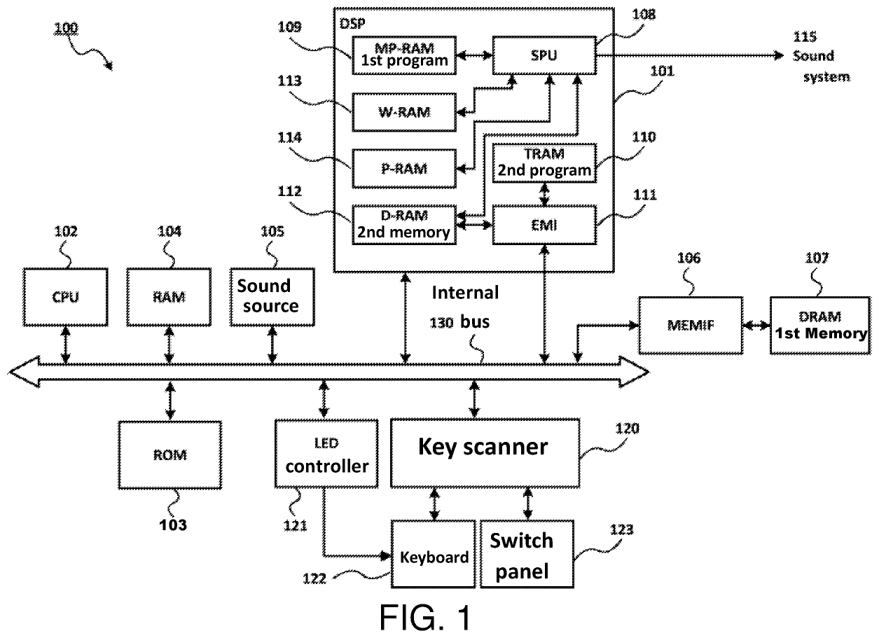

Hereinafter, embodiments of the present disclosure are explained in detail with reference to the drawings. FIG. 1 is a block diagram of an embodiment 100 of an electronic musical instrument according to the present invention, hereinafter referred to as “electronic musical instrument 100.”

The electronic musical instrument 100 includes a CPU (Central Processing Unit) 102, a ROM (Read Only Memory) 103, a RAM (Random Access Memory) 104, a sound source 105, a DSP 101, a memory interface circuit (MEMIF: MEMory Interface) 106 to which an external memory (DRAM: Dynamic RAM) 107, which is a first memory, is connected, a key scanner 120 to which a keyboard 122 for performance (performance operators) and a switch panel 123 are connected, and an LED controller 121 for causing each key of the keyboard 122 to emit light. 121, all of which are interconnected by an internal bus 130.

The CPU 102 controls the overall operation of the electronic musical instrument. The ROM 103 stores a control program, which is read out to the RAM 104 and executed by the CPU 102, and its working data. This control program detects the playing state of the keyboard 122 and various operating states of the switch panel 123 via the key scanner 120, and, based on these playing state and operating states, executes operations providing instructions for sound generation and sound muting to the sound source 105.

MEMIF 106 controls access to the external memory (DRAM) 107.

The sound source 105 is a circuit that generates musical waveform data based on instructions from the control program executed by the CPU 102, and may be called a wave generator WG. The generated musical waveform data is transferred to the D-RAM 112 as a second memory within the DSP 101 via the internal bus 130, MEMIF 106, and D-RAM (Dynamic-RAM) 112 by burst access, which will be described later.

DSP 101 includes SPU (Signal Processing Unit) 108, MP-RAM (Main Program-RAM) 109, TRAM (Transfer RAM) 110, EMI (External Memory Interface) 111, internal memory (D-RAM) 112, W-RAM (Work RAM) 113, and P-RAM (Parameter RAM) 114.

The SPU 108 is a processor that controls the overall operation of the DSP 101.

The MP-RAM 109 is a memory that stores the main program (first program) of the DSP 101 executed by the SPU 108. The main program (first program) is a program for adding sound effects to the waveform data samples transferred to the D-RAM 112 as a second memory.

The TRAM 110 is a memory that stores a subprogram (second program) of the DSP 101 executed by the SPU 108. The subprogram (second program) performs burst access to a plurality of samples of waveform data stored in the external memory (DRAM: Dynamic RAM) 107 as a first memory and transfers them to the D-RAM 112 as a second memory. In this embodiment, the sub-program (second program) and the main program (first program) are developed to respective memories as separate programs, so that the execution schedule of each program can be controlled adequately.

EMI 111 is an interface circuit that controls access to external memory (DRAM) 107.

The internal memory (D-RAM) 112 as the second memory is an internal memory of the DSP 101 and is used as a mirror memory of the external memory (DRAM) 107 as the first memory.

W-RAM 113 is a working memory used in signal processing executed by SPU 108.

P-RAM 114 is a memory that stores parameter data used in signal processing executed by SPU 108.

The main program stored in the MP-RAM 109, the sub-program stored in the TRAM 110, the burst number in burst access, which will be described later, the parameter data stored in the P-RAM 114, etc., can be set, changed, and re-set by the CPU 102 via the internal bus 130.

The musical waveform data to which the sound effects have been applied by the DSP 101 is output from the SPU 108 to an external sound system 115 consisting of a D/A converter, an amplifier, a speaker, etc., which are not shown, so as to be sounded.

By executing the main program stored in the MP-RAM 109, the SPU 108 uses the parameter data stored in the P-RAM 114, uses the W-RAM 113 as a working memory, and executes operations for applying sound effects on the musical waveform data prefetched (described later) from the external memory (DRAM) 107 to the D-RAM 112. Independently from the main program, the SPU 108 executes the subprogram stored in the TRAM 110 to prefetch (described later) the musical waveform data stored in the external memory (DRAM) 107 into the internal memory (DRAM) 112 within the DSP 101, which is capable of high-speed processing. The SPU 108 executes signal processing such as sound effect imparting processing on the musical waveform data that have been transferred to the internal memory (D-RAM) 112.

With the main program, the SPU 108 does not directly access the external memory (DRAM) 107 when executing effect processing (mainly delay processing) using the external memory (DRAM) 107. In this case, the EMI 111 first accesses the internal bus 130 based on a subprogram which consists of commands describing access addresses read from the TRAM 110 and processing contents (read/write, burst access/single access, etc., which will be described later). If the access destination is the external memory (DRAM) 107, the external memory (DRAM) 107 is accessed via the MEMIF 106. However, the access destination may be the internal memory (D-RAM) 112.

With the main program, the SPU 108 outputs the musical waveform data in the internal memory (D-RAM) 112 or W-RAM 113 that have undergone sound effect imparting processing to the external sound system 115 (not shown).

The DSP 101 executes the series of processes described above in real time as the sampling time/period progresses. In this case, the DSP 101 executes prefetch/poststore control processing with respect to the external memory (DRAM) 107. Prefetch/poststore is a function of mirroring an external memory, which has a slow access speed, to a high-speed internal memory (D-RAM) 112 in the DSP 101, so to speak.

The prefetching is an operation of preparing the musical waveform data in the internal memory (D-RAM) 112, which is a fast memory within the DSP 101, by executing a read command to the external memory (DRAM) 107 before the SPU 108 of the DSP 101 executes the read command to the internal memory (D-RAM) 112.

The post-store is an operation of writing the musical waveform data, which have been temporarily stored in the high-speed internal memory (D-RAM) 112 by a write command issued to the internal memory (D-RAM) 112 by the DSP 101, onto the external memory (DRAM) 107 at a later timing. The prefetch and poststore operations described above are executed at timings different from the read/write operations for the internal memory (D-RAM) 112 within the DSP 101. Therefore, the SPU 108 of the DSP 101 executes internal read/write processing for the internal memory and accompanying sound effect imparting processing (signal processing) by the main program stored in the MP-RAM 109. On the other hand, the SPU 108 executes prefetch/poststore processing by the subprogram stored in the TRAM 110 in the DSP 101 separately from the main program.

The subprogram that executes prefetch/poststore control does not run at the same timing as the main program. Therefore, if the execution timing of the subprogram is not set correctly with respect to the execution of the main program, the prefetch may not be in time for the execution of the main program, and the main program may be executed even though the poststore has not been executed. Thereby, the sample data of the musical waveform data in the internal memory (D-RAM) 112 to be written in the external memory (D-RAM) 107 may be overwritten, causing a mismatch to occur, and the DSP 101 does not operate properly.

In the DSP 101 that executes the processing of the main program in each sampling time/period, unless prefetch/poststore with respect to the external memory (DRAM) 107 are completed within the sampling period, all the accesses cannot be completed. In order to efficiently perform many memory accesses, it is necessary to shorten the access time. Therefore, in this embodiment, the external memory (DRAM) 107 is constituted of an SDRAM (Synchronous DRAM), DDR-SDRAM (Double Data Rate-SDRAM) or the like, and burst access is used as data access between this external memory (DRAM) 107 and internal memory (D-RAM) 112 in the DSP 101 in order to reduce the access time.

Burst access is a function that allows batch access between multiple addresses in the internal memory (D-RAM) 112 of the DSP 101 and multiple addresses in the external memory (DRAM) 107 by issuing one instruction. The number of batch accesses is called the burst number. For example, if the burst number, that is, the number of samples of musical waveform data to be accessed at one time, is four, consecutive four addresses can be accessed at once at high speed. Therefore, in simple terms, the subprogram can be considered to execute one unit of processing in four sampling periods.

However, in this embodiment, the execution schedule of the second program is determined so that the execution of the first program and the second program is completed once every sampling period of the waveform data.

Here, the meaning of one processing unit is, for example, in the case of access from the external memory (DRAM) 107 to the internal memory (D-RAM) 112 for prefetching only samples of musical waveform data in the next four sampling periods, a unit in which prefetch burst read access only for the four sampling periods is executed.

On the other hand, as in delay effect processing, for example, when post-store burst write access of samples of musical waveform data for the current four sampling times/periods from the internal memory (D-RAM) 112 to the external memory (DRAM) 107, and prefetch burst read access of the delayed musical waveform data for the next four sampling timesperiods from the external memory (DRAM) 107 to the internal memory (D-RAM) 112 are to be executed, a unit in which the above-described post-store burst write access and the subsequent prefetch burst read access are executed as a set is one processing unit.

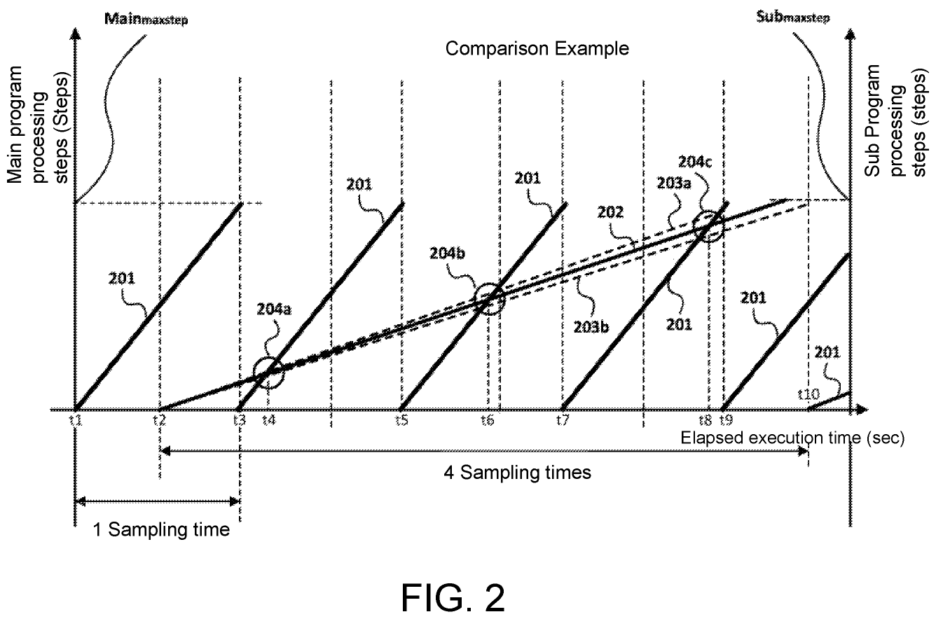

FIG. 2 is a diagram illustrating, as a comparative example, a relationship between the processing of the main program and the execution timing of subprograms that execute one processing unit per four sampling periods. The vertical axis on the left end in FIG. 2 indicates the processing steps (unit: [step]) of the main program, and the vertical axis on the right end in FIG. 2 indicates the processing steps (unit: [step]) of the subprogram. The scales of the left vertical axis and the right vertical axis can be different. The horizontal axis indicates the elapsed program execution time (in units of [seconds]).

The thick solid line 201 indicates the execution state of the main program, and indicates that the processing steps of the main program linearly increase as the elapsed execution time increases from time t1 when the number of processing steps of the main program is 0. At time t3 when one sampling period has elapsed from t1, the processing step of the main program reaches the maximum value Mainmaxstep, and signal processing for one unit is completed. Thereafter, the main program repeats the same signal processing for each sampling period, such as t3→t5, t5→t7, t7→t9, t9→t11, t11→t13, t13→t15.

The thin solid line 202 indicates the execution state of the subprogram. The subprogram starts processing at time t2, which is, for example, half the sampling period after time t1 when the main program indicated by the thick solid line 201 started executing. As the elapsed execution time increases from this time t2, the processing steps of the subprogram also increase linearly, but the processing step of the subprogram reaches the maximum value Submaxstep at time t10 which is 4 sampling periods since the time t2 which is 0 step. That is, the thin solid line 202 indicates that the subprogram that executes one processing unit of prefetch/poststore is executed once in every four sampling periods. After time t10, the subprogram repeatedly executes the same burst access process every four sampling periods.

Here, with respect to the execution of the subprogram, at time points t4, t6, and t8 of the respective points surrounded by circle marks 204a, 204b, and 204c indicated by execution elapsed times t4, t6, and t8, the thick solid line 201 of the main program and the thin solid line 202 of the subprogram intersect. Furthermore, the execution state of the subprogram indicated by the thin solid line 202 can fluctuate, for example, within the range of thin dashed lines 203a to 203b depending on the load state of the internal bus 130.

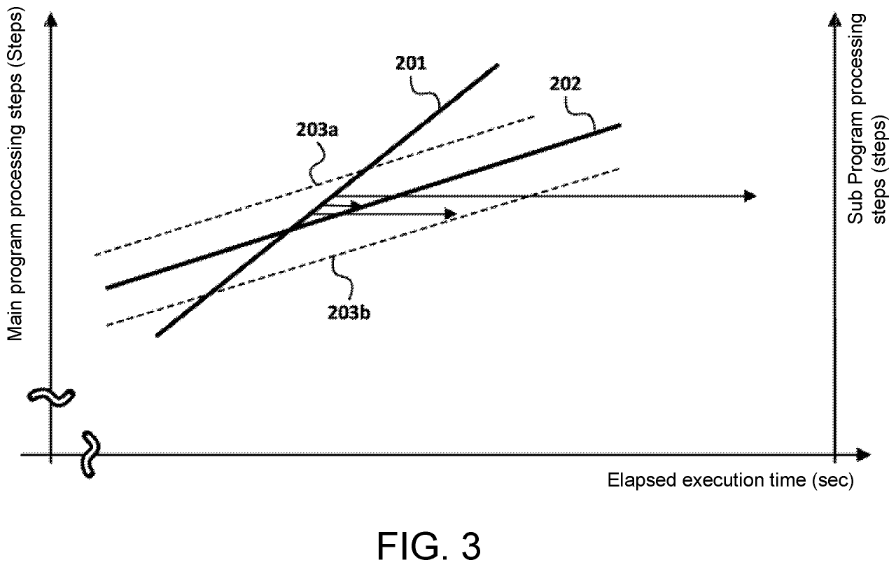

Therefore, as shown in FIG. 3, in a certain sampling period, if an access occurs at any of the times t4, t6, and t8 indicated by circles 204a, 204b, and 204c in FIG. 2, when the execution state of the subprogram is on the side of the thin solid line 202 or the thin dashed line 203b, for example, during that sampling period, after the main program writes musical waveform data to the internal memory (D-RAM) 112, the subprogram normally executes the post-store burst write access from the internal memory (D-RAM) 112 to the external memory (DRAM) 107 for the samples of the musical waveform data that have been written.

On the other hand, as shown in FIG. 3, if an access occurs at any of the circles 204a, 204b, and 204c during a certain sampling period, when the execution state of the subprogram is on the side of the thin dashed line 203a, for example, during that sampling period, the subprogram is executed before the main program writes the musical waveform data to the internal memory (D-RAM) 112. Therefore, the musical waveform data written in the internal memory (D-RAM) 112 is post-stored in the external memory (DRAM) 107 at the timing when post-storage of the subprogram is executed at the next sampling period, and burst access is not executed properly as a result.

As described with reference to FIGS. 2 and 3, if the execution schedule is simply set so that one processing unit of the subprogram is executed once every four sampling periods, the execution timings of the main program and the subprogram may intersect, and prefetch/poststore data integrity may not be maintained in such cases. In the case of prefetch/poststore to actually realize the delay effect, the ring address is used for memory addressing, so the absolute time of which subprogram is executed is not important, which program—the main program or subprogram—is executed first may change in each sampling period, and the relative execution time of the main program and the subprogram may change (signal discontinuity occurs), which causes problematic discontinuity of the signals.

Therefore, in this embodiment, in order to prevent inconsistency in access order with access to the internal memory (D-RAM) 112 (second memory) by execution of the main program (first program) by the SPU 108 (processor) of the DSP 101, the execution schedule of bust access, which instructs simultaneous access between a plurality of addresses of the internal memory (D-RAM) 112 and a plurality of addresses of the external memory (DRAM) 107, is predetermined in relation to the sampling period based on the burst number, which indicates the number of simultaneous access of the bust access.

The SPU 108 executes burst access between the internal memory (D-RAM) 112 and the external memory (DRAM) 107 by executing the subprogram according to the determined execution schedule. Further, the SPU 108 repeatedly executes the main program at each sampling period to perform signal processing, such as applying sound effects and the like, on the musical waveform data that has been stored in the internal memory (D-RAM) 112 as acquired from the external memory (DRAM) 107. The SPU 108 outputs the resulting musical waveform data to the external sound system 115, for example. Alternatively, for example, the musical waveform data obtained in the delay effect processing is written in the internal memory (D-RAM) 112 in order to be delayed in the external memory (DRAM) 107.

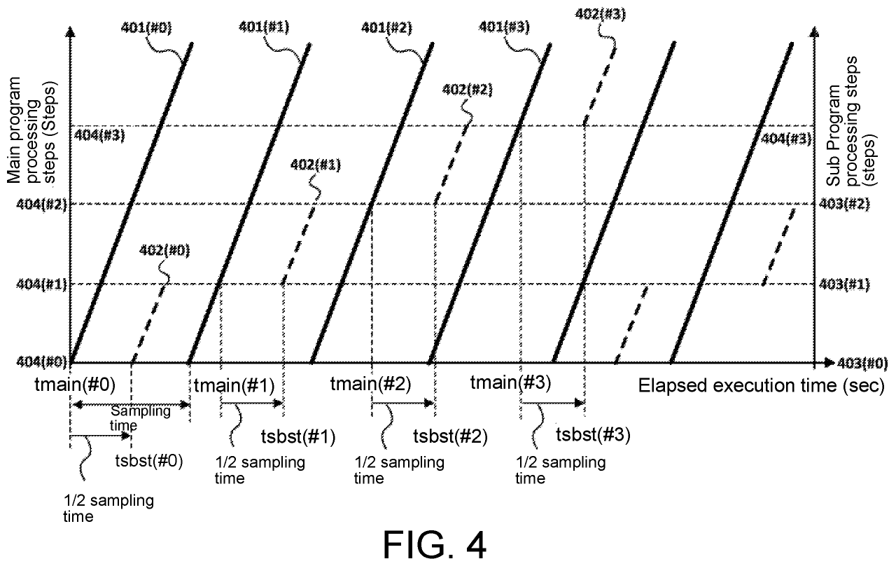

FIG. 4 is an explanatory diagram of the first embodiment of the present invention of the method of determining the execution schedule described above. In determining the execution schedule, first, the subprogram (second program) is divided into divided subprograms, the number of which corresponds to the burst number, so that the each of the divided subprograms corresponds to the main program that is executed in the same sampling period.

For example, when the burst number 4, as shown in FIG. 4, the four divided subprograms 402 (#0), 402 (#1), 402 (#2), and 402 (#3) are matched with the main programs 401 (#0), 401 (#1), 401 (#2), and 401 (#3), which are respectively executed in sampling period T (#0), sampling period T (#1), sampling period T (#3), and sampling period T (#4).

Then, each of the divided subprograms described above is each executed at successive sampling periods the number of which corresponds to the burst number.

For example, as shown in FIG. 4, the respective ones of four divided subprograms 402 (#0), 402 (#1), 402 (#2), and 402 (#3) are respectively repeated at the four consecutive sampling periods T (#0), T (#1), T (#3), and T (#4) corresponding to the burst number. The same is true thereafter.

At this time, the start timing of each divided subprogram at each sampling period is determined to be a predetermined period of time after the main program performs a processing step that is the same as the processing step the corresponding divided subprogram is going to perform.

For example, in FIG. 4, the respective start timings tsbst (#0), tsbst (#1), tsbst (#3), and tsbst (#4) of the divided subprograms 402 (#0), 402 (#1), 402 (#2), and 402 (#3) for the sampling periods T (#0), T (#1), T (#3), and T (#4) are set to be ½ sampling period later than the respective timings tmain (#0), tmain (#1), tmain (#3), and tmain (#4) at which the main programs 401 (#0), 401 (#1), 401 (#2), and 401 (#3) execute the respective processing steps 404 (#0), 404 (#1), 404 (#2), and 404 (#3) that are respectively the same as the processing steps 403 (#0), 403 (#1), 403 (#2), and 403 (#3), which the respective divided subprograms 402 (#0), 402 (#1), 402 (#2), and 402 (#3) for the respective sampling period T (#0), T (#1), T (#3), and T (#4) are going to execute at their beginnings.

In the first embodiment of the method for determining the execution schedule shown in FIG. 4, the rate of increase in the processing steps of the divided subprogram 402 per elapsed execution time can be made the same as the rate of increase in the processing steps of the main program 401 per elapsed execution time. As described above, the start timing of each divided subprogram at each sampling period is set to a predetermined time later than the timing at which the main program executes the same processing step as the processing step the corresponding subprogram is going to execute at its beginning in the sampling period. Therefore, a sufficient difference in execution time between the divided subprogram 402 and the main program 401 can be ensured, and their execution timings will not intersect. As a result, data consistency is maintained during prefetch/poststore burst access.

As a result, the first embodiment of the method for determining the execution schedule shown in FIG. 4 makes it possible to reduce the load on the bus to which the external memory (DRAM) 107 shared with the CPU 102 and the sound source 105 is connected, and it becomes possible to reduce influences upon the CPU 102 and the sound source 105 due to an increase in accesses to the external memory (DRAM) 107 by the DSP 101. As a result, the DSP 101 can increase variations in sound effect applications.

In this way, the execution schedule of the second program is determined such that the start timing of each of the second programs that are divided and to be executed into a number corresponding to the burst number is set to a prescribed timing after the start timing of each execution of the corresponding first program. Further, the execution schedule of the second program is determined so that execution of the second program is completed once in each sampling period for the waveform data.

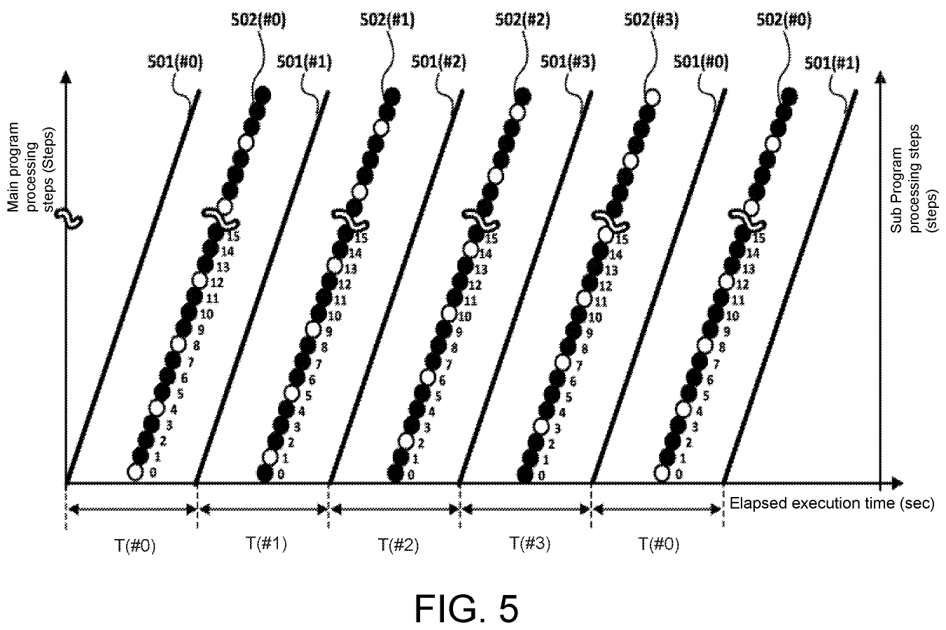

FIG. 5 is an explanatory diagram showing a second embodiment of a method for determining an execution schedule. In determining the execution schedule, at each sampling period, at the execution timing of each processing step of the subprogram (second program), the burst access is scheduled if the processing step to be executed is bust access corresponding to (matching) the step to be executed by the main program (first program) in the sampling period, and the bust access is not executed in any other case.

For example, when the number of bursts is 4, in the subprograms 502 (#0), 502 (#1), 502 (#2), and 502 (#3) to be executed in the respective sampling periods T (#0), T (#1), T (#3), and T (#4) shown in FIG. 5, “◯” and “●” indicate the execution status of each processing step; “◯” indicates burst access is executed, and “●” indicates that burst access is not executed and the processing step is simply skipped.

In this example, the sampling period is changed from the value “0” to “bust number−1] as in 0, 1, 2, 3, 0, 1, 2, 3, etc., corresponding to the burst number (burst number=4 in the example in FIG. 5). The count value obtained by repeatedly counting the burst number (4 counts in the example of FIG. 5) up to the value “number of bursts −1” will be referred to as the sampling counter value.

In the example of FIG. 5, in subprogram 502 (#0) executed in sampling period T (#0) where the sampling counter value is 0, the execution status of processing steps 0, 4, 8, 12, etc., i.e., the processing steps in which the remainder value obtained by dividing by the number of bursts=4 is 0, is set to “◯” and burst access is executed, and the execution status of other processing steps is set to “●” and burst access is not executed, thereby skipping those processing steps. In this case, in the processing steps=0, 4, 8, 12, etc., of the subprogram 502 (#0) in which the remainder value obtained by dividing by the burst number=4 is 0, instructions for access (burst access or single access to be described later) consistent with the main program 501 (#0) to be executed in sampling period T (#0) are stored in advance.

Similarly, in subprogram 502 (#1) executed in sampling period T (#1) where the sampling counter value is 1, the execution status of processing steps 1, 5, 9, 13, etc., i.e., the processing steps in which the remainder value obtained by dividing by the number of bursts=4 is 1, is set to “◯” and burst access is executed, and the execution status of other processing steps is set to “●” and burst access is not executed, thereby skipping those processing steps. In this case, in the processing steps 1, 5, 9, 13, etc., of subprogram 502 (#1), in which the remainder value obtained by dividing by the number of bursts=4 is 1, instructions for access (burst access or single access described later) consistent with the main program 501 (#1) to be executed in the sampling period T (#1) are stored in advance.

Similarly, in the subprogram 502 (#2) executed in the sampling period T (#2) where the sampling counter value is 2, the execution status of the processing steps, 2, 6, 10, 14, etc., i.e., the processing steps whose remainder value obtained by dividing by the number of bursts=4, is 2 is set to “◯” and burst access is executed, and the execution status of other processing steps is set to “●” and burst access is not executed, thereby skipping those processing steps. In this case, in the processing steps 2, 6, 10, 14, etc., of subprogram 502(#2), in which the remainder value obtained by dividing by the number of bursts=4 is 2, instructions for access (burst access or single access to be described later) consistent with the main program 501 (#2) to be executed in the sampling period T (#2) are stored in advance.

Similarly, in the subprogram 502 (#3) executed in the sampling period T (#3) where the sampling counter value is 3, the execution status of the processing steps, 3, 7, 11, 15, etc., i.e., the processing steps whose remainder value obtained by dividing by the number of bursts=4 is 3, is set to “◯” and burst access is executed, and the execution status of other processing steps is set to “●” and burst access is not executed, thereby skipping those processing steps. In this case, in the processing steps 3, 7, 11, 15, etc., of subprogram 502(#3), in which the remainder value obtained by dividing by the number of bursts=4 is 3, instructions for access (burst access or single access to be described later) consistent with the main program 501 (#3) to be executed in the sampling period T (#3) are stored in advance.

In the second embodiment of FIG. 5, the start timing of each subprogram in each sampling period is determined to be a predetermined time later than the start timing of the main program in each sampling period.

For example, in FIG. 5, the respective start timings st (#0), st (#1), st (#3), and st (#4) of the subprograms 502 (#0), 502 (#1), 502 (#2) and 502 (#3) in the respective sampling periods T (#0), T (#1), T (#3), and T (#4) are set to, for example, ½ sampling period after the starting timings of the main programs 501 (#0), 501 (#1), 501 (#2), and 501 (#3) in the respective sampling times/periods T (#0), T (#1), T (#3), and T (#4).

In the second embodiment of the method for determining the execution schedule shown in FIG. 5, as in the first embodiment shown in FIG. 4, the increase rate of processing steps of the subprograms 502 per elapsed time can be made the same as the increase rate of processing steps of the main program 501 per elapsed time. Then, as described above, the start timing of each of the divided subprograms in each of the sampling periods is determined to be a predetermined time later than the start timing of the corresponding main program in the corresponding sampling period. Thus, as in the case of the first embodiment shown in FIG. 4, a sufficient difference in execution time between the subprogram 502 and the main program 501 can be ensured, and the execution timings of the two do not intersect, thereby maintaining the integrity of the data in burst access of prefetch/poststore. In this way, the second program is executed in increments in the unit of the burst number—i.e., at intervals corresponding to the burst number

As a result, as in the case of the first embodiment shown in FIG. 4, according to the second embodiment of the method for determining the execution schedule shown in FIG. 5, it becomes possible to reduce the load on the bus to which the DSP 101 is connected, and it becomes possible to reduce the influence on the CPU 102 and the sound source 105 due to increased access to the external memory (DRAM) 107 by the DSP 101. As a result, the DSP 101 can increase variations in sound effect applications.

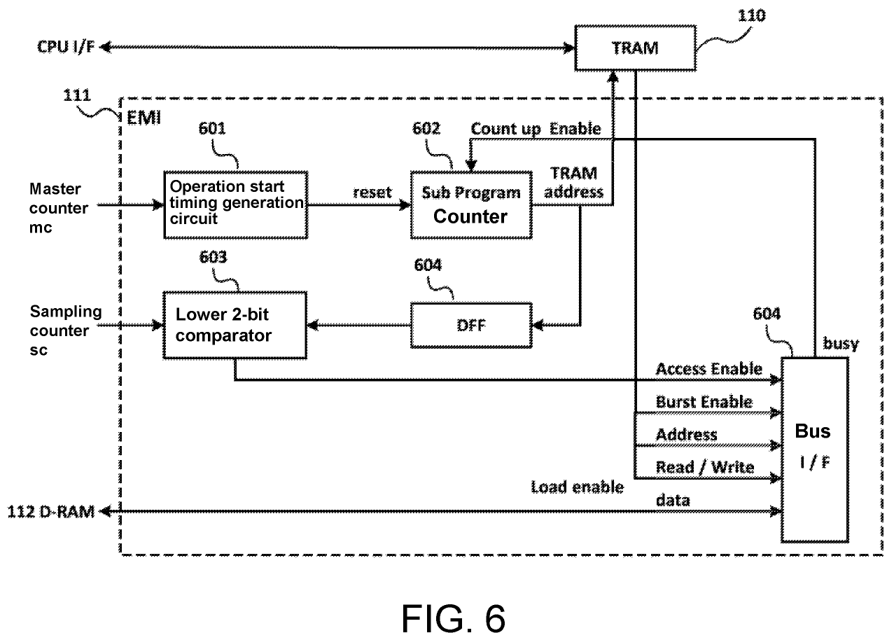

FIG. 6 is a hardware configuration diagram showing an embodiment of the EMI 111 in FIG. 1 for realizing the second embodiment of the method for determining the execution schedule shown in FIG. 5.

First, as described above, the TRAM 110 in FIG. 1 stores instruction data for each processing step of a subprogram. The contents of TRAM 110 can be loaded in advance from CPU 102 in FIG. 1 via the internal bus 130.

The operation start timing generation circuit 601 generates a reset signal “reset” that instructs the operation start timing of each subprogram at each sampling period. Specifically, the operation start timing generation circuit 601 generates the reset signal “reset” that resets the sub program counter 602 once every sampling period using a master counter mc inputted from a circuit not shown in the drawings.

More specifically, the operation start timing generation circuit 601 asserts the reset signal “reset” that is input to the program counter 602 when the value of the master counter mc, which changes from value 0 to value 4095 for each sampling period, reaches 2047, which corresponds to ½ sampling period, for example. As a result, in the example of FIG. 5, the respective start timings st (#0), st (#1), st (#3), and st (#4) of the subprograms 502 (#0) and 502 (#1), 502 (#2), and 502 (#3) in the sampling periods T (#0), T (#1), T (#3), and T (#4) are respectively set to be ½ sampling period after the respective start timings of the main programs 501 (#0), 501 (#1), 501 (#2), and 501 (#3) in the sampling periods T(#0), T (#1), T (#3), and T (#4).

The sub program counter 602 (program counter circuit) outputs TRAM address, which is a program counter value that counts up from 0 at predetermined time intervals obtained by subdividing the sampling period, at the timing when the reset signal “reset” from the operation start timing generation circuit 601 is asserted in every sampling period. If the bus I/F circuit 604 (described later) asserts a busy signal indicating that the internal bus 130 in FIG. 1 is busy, the count-up operation of the TRAM address is temporarily stopped until the busy signal is negated. As a result, the execution speed of the subprogram changes depending on the access state of the internal bus 130.

A DFF (D-Flip Flop) circuit 605 temporarily holds the TRAM address output from the sub program counter 602.

A lower 2-bit comparator 603 (lower bit comparison circuit) compares values of the lower bits corresponding to the burst number (which, in the example of FIG. 5, since the burst number=4, correspond to the lower 2 bits for identifying the four sampling periods) of the TRAM address (program counter value) with the lower 2 bits corresponding the number of bursts=4 of the value of the sampling counter sc (sampling counter value) that counts up at each sampling event. If the lower two bits that are compared match to each other, the lower 2-bit comparator 603 asserts the Access Enable signal, and, if they do not match, the lower 2-bit comparator 603 negates the Access Enable signal.

As described above in the explanation of FIG. 5, the sampling counter value is counted repeatedly from the value “0” to the value “number of bursts—1”—i.e. the count of the burst number (4 counts in the example of FIG. 5), such as, for example, 0, 1, 2, 3, 0, 1, 2, 3, etc., corresponding to the burst number (in the example of FIG. 5, the burst number=4). The lower 2-bit comparator 603 compares the lower 2-bit of the TRAM address, selects one of the four consecutive processing steps of the subprogram, and generates the Access Enable signal.

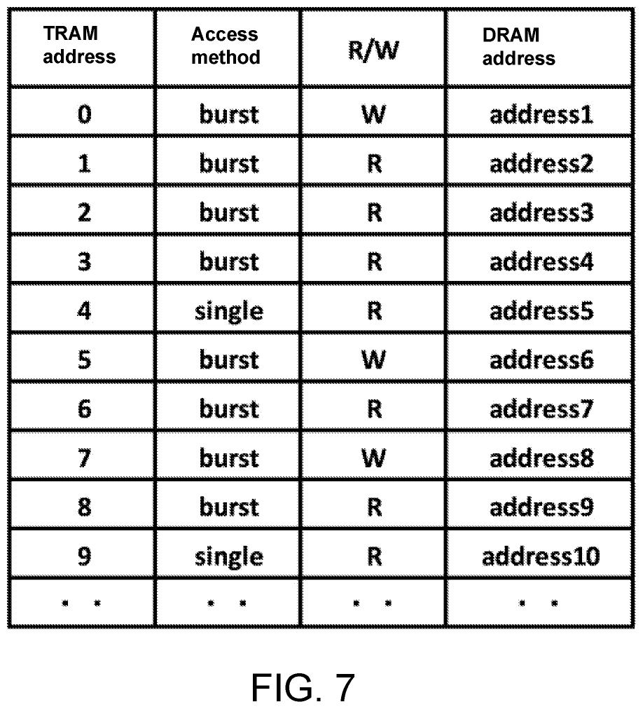

The TRAM 110 outputs instruction data of the processing step that corresponds to the TRAM address outputted by the Sub Program counter 602 to the bus I/F circuit 604 (bus interface circuit). FIG. 7 is a diagram showing an example of the structure of the instruction data. For example, the instruction data includes values for each of “TRAM address” specified by TRAM address, “R/W” indicating the read or write processing content, “DRAM address” specifying the access destination address, and “Access Method” specifying burst access or single access.

As shown in FIGS. 6 and 7, the TRAM 110 outputs the Read/Write data based on the “R/W” item value of the instruction data corresponding to the TRAM address, outputs the Address data based on the “address” item value, and outputs the Burst Enable signal based on the “Access Method” item value to the bus I/F circuit 604.

The bus I/F circuit 604, outputs Read/Write data, Address data and the instruction data instructing burst access to the internal bus 130 of FIG. 1 when the lower 2-bit comparator 603 asserts the Access Enable signal, and TRAM 110 asserts the Burst Enable signal based on the TRAM address (program counter value) output from the Sub Program counter 602.

The instruction data for each processing step of the subprogram is read out sequentially based on the TRAM address output from the Sub Program counter 602, and an actual burst access is performed only when the Access Enable signal, which is generated once in every 4 processing steps by comparing the lower two bits of the sampling counter sc with the TRAM address, is asserted.

Under the control of the bus I/F circuit 604 described above, as described above with reference to FIG. 5, with respect to the instruction data for burst access for the subprogram 502 (#0) to be executed in the sampling period T (#0) having the sampling counter sc of 0, in processing steps 0, 4, 8, 12, etc., where the lower two bits of TRAM address are 0, actual burst access is performed because the Access Enable signal and the Burst Enable signal are asserted. The burst access instruction data of the other processing steps are skipped because the Access Enable signal is negated although the Burst Enable signal is asserted.

Similarly, with respect to the instruction data for burst access for the subprogram 502 (#1) to be executed in the sampling period T (#1) having the sampling counter sc of 1, in processing steps 1, 5, 9, 13, etc., where the lower two bits of TRAM address are 1, actual burst access is performed because the Access Enable signal and the Burst Enable signal are asserted. The burst access instruction data of the other processing steps are skipped because the Access Enable signal is negated although the Burst Enable signal is asserted.

Similarly, with respect to the instruction data for burst access for the subprogram 502 (#2) to be executed in the sampling period T (#2) having the sampling counter sc of 2, in processing steps 2, 6, 10, 14, etc., where the lower two bits of TRAM address are 2, actual burst access is performed because the Access Enable signal and the Burst Enable signal are asserted. The burst access instruction data of the other processing steps are skipped because the Access Enable signal is negated although the Burst Enable signal is asserted.

Similarly, with respect to the instruction data for burst access for the subprogram 502 (#3) to be executed in the sampling period T (#3) having the sampling counter sc of 3, in processing steps 3, 7, 11, 15, etc., where the lower two bits of TRAM address are 1, actual burst access is performed because the Access Enable signal and the Burst Enable signal are asserted. The burst access instruction data of the other processing steps are skipped because the Access Enable signal is negated although the Burst Enable signal is asserted.

As described above in the explanation of FIG. 5, in the respective processing steps of the subprogram that is stored in the TRAM 110 from the CPU 102, instructions to execute access that is consistent with the main program's execution at the sampling period corresponding to the sampling counter sc are pre-stored.

Specifically, in the subprogram stored from the CPU 102 to the TRAM 110, in the processing steps=0, 4, 8, 12, etc. where the lower two bits of the “TRAM address” item value (FIG. 7) are 0, the access instructions consistent with the main program 501 (#0) to be executed in sampling period T (#0) are stored.

Similarly, in the processing steps=1, 5, 9, 13, etc., where the lower two bits of the “TRAM address” item value are 1, the access instructions consistent with the main program 501 (#1) to be executed in sampling period T (#1) are stored.

Similarly, in the processing steps=2, 6, 10, 14, etc., where the lower two bits of the “TRAM address” item value are 2, the access instructions consistent with the main program 501 (#2) to be executed in sampling period T (#2) are stored.

Similarly, in the processing steps=3, 7, 11, 15, etc., where the lower two bits of the “TRAM address” item value are 3, the access instructions consistent with the main program 501 (#3) to be executed in sampling period T (#3) are stored.

Here, when the instruction data output from TRAM 110 instructs a single access to the external memory (DRAM) 107 or the internal memory (D-RAM) 112, and the Burst Enable signal output from TRAM 110 is therefore negated, the bus I/F circuit 604 in FIG. 6 outputs instruction data instructing a single access to the internal bus 130 regardless of the state of the Access Enable signal.

As described above, the signals read/written by accessing the internal bus 130 by the bus I/F circuit 604 are stored in or read out from the high-speed internal memory (D-RAM) 112 within the DSP 101.

According to the embodiments described above, it becomes possible to ensure a sufficient difference in execution time between the subprogram and the main program in each sampling period, and the execution timings of the two do not intersect. Therefore, data consistency is maintained during the prefetch/poststore burst access. As a result, it becomes possible to reduce the load on the bus shared with the CPU 102 and the sound source 105 to which the external memory (DRAM) 107 is connected, and it becomes possible to reduce the influence upon the CPU 102 and the sound source 105 due to an increase in access to the external memory (DRAM) 107 by the DSP 101. As a result, the DSP 101 can increase variations in sound effect applications.

In addition to improving processing performance with burst access, it can also support signal processing that requires single access (for example, when the reference destination address is not sequentially incremented but discontinuous, such as in a chorus effector).

Although the embodiments described above disclose examples in which the DSP 101 is used to impart acoustic effects in an electronic musical instrument, the present invention is not limited thereto, and can be applied to various uses by linking the signal processing device with an external memory.

According to the present invention, burst access is used for data transfer between an internal memory and an external memory of a signal processing device to reduce the frequency of external memory access, reduce competitions for bus access, and to ensure consistency with memory access between burst access and access to the internal memory by the signal processing device.

It will be apparent to those skilled in the art that various modifications and variations can be made in the present invention without departing from the spirit or scope of the invention. Thus, it is intended that the present invention cover modifications and variations that come within the scope of the appended claims and their equivalents. In particular, it is explicitly contemplated that any part or whole of any two or more of the embodiments and their modifications described above can be combined and regarded within the scope of the present invention.

What is claimed is:

1. A signal processing device, comprising:
a first memory storing waveform data;
a second memory to which the waveform data is being transferred; and
a processor configured to execute a first program that imparts a sound effect to samples of the waveform data that have been transferred to the second memory, and a second program that performs burst access to a plurality of samples of the waveform data stored in the first memory so as to transfer the plurality of samples of the waveform data to the second memory,
wherein the processor determines an execution schedule of the second program such that a process execution of the first program and a process execution of the second program are respectively completed once in every sampling period of the waveform data.

2. The signal processor device according to claim 1, wherein by executing the second program, the processor transfers, from the first memory to the second memory, the plurality of samples of the waveform data corresponding to a burst number of the burst access throughout a plurality of sampling periods corresponding to the burst number.

3. The signal processor device according to claim 1, wherein the processor determines the execution schedule of the second program such that a start timing of a process in the second program is a predetermined time later than a start timing of said process in the first program.

4. The signal processor device according to claim 1, wherein the processor executes steps of the second program as a burst access process at every number of steps that corresponds to a burst number of the burst access.

5. The signal processor device according to claim 1, further comprising:
an operation start timing generation circuit that generates a reset signal instructing an operation start timing of the second program;
a program counter circuit that counts up at predetermined time intervals obtained by subdividing the sampling period and outputs a resulting program counter value at a timing when the reset signal is asserted from the operation start timing generation circuit for each sampling period;
a lower bit comparison circuit that compares values of one or more of lower bits of the program counter value corresponding to a burst number of the burst access with values of the one or more of lower bits of a sampling counter value that counts up at every sampling period corresponding to the burst number of the burst access; and
a bus interface circuit that, when the lower bit comparison circuit detects a matching in the one or more of lower bits and instruction data output from a program memory based on the program counter value indicates a burst access, outputs said instruction data that instruct the burst access.

6. The signal processor device according to claim 1,
wherein each of instructions of processing steps of the second program includes access identification information indicating whether the instruction instructs execution of the burst access or instructs execution of a single access that instructs access to a single address in the second memory, and
wherein when executing an instruction of a processing step of the second program, if the access identification information of the instruction indicates the instruction instructs the execution of the single access, the processor performs the single access between the second memory and the first memory based on the instruction.

7. An electronic musical instrument, comprising;
the signal processing device as set forth in claim 1; and
a performance operator,
wherein the waveform data is transferred from the first memory to the second memory in response to an operation on the performance operation.

8. A method of signal processing executed by a processor in a signal processing device that includes, in addition to the processor: a first memory storing waveform data; and a second memory to which the waveform data is being transferred, the method comprising, via the processor:
executing a first program that imparts a sound effect to samples of the waveform data that have been transferred to the second memory, and a second program that performs burst access to a plurality of samples of the waveform data stored in the first memory so as to transfer the plurality of samples of the waveform data to the second memory; and
determining an execution schedule of the second program such that a process execution of the first program and a process execution of the second program are respectively completed once in every sampling period of the waveform data.

9. The method according to claim 8, wherein the executing of the second program, includes transferring from the first memory to the second memory, the plurality of samples of the waveform data corresponding to a burst number of the burst access throughout a plurality of sampling periods corresponding to the burst number.

10. The method according to claim 8, wherein the execution schedule of the second program is determined such that a start timing of a process in the second program is a predetermined time later than a start timing of said process in the first program.

11. The method according to claim 8, wherein steps of the second program are executed as a burst access process at every number of steps that corresponds to a burst number of the burst access.

12. The method according to claim 8,
wherein each of instructions of processing steps of the second program from the processor includes access identification information indicating whether the instruction instructs execution of the burst access or instructs execution of a single access that instructs access to a single address in the second memory, and
wherein when executing an instruction of a processing step of the second program, if the access identification information of the instruction indicates the instruction instructs the execution of the single access, the single access is performed between the second memory and the first memory based on the instruction.

13. A non-transitory computer readable storage medium storing instructions to be executed by a processor in a signal processing device that includes, in addition to the processor:
a first memory storing waveform data; and a second memory to which the waveform data is being transferred, the method comprising, via the processor, the instructions causing the professor to perform the following:
executing a first program that imparts a sound effect to samples of the waveform data that have been transferred to the second memory, and a second program that performs burst access to a plurality of samples of the waveform data stored in the first memory so as to transfer the plurality of samples of the waveform data to the second memory; and
determining an execution schedule of the second program such that a process execution of the first program and a process execution of the second program are respectively completed once in every sampling period of the waveform data.
